(19) United States
(12) Patent Application Publication
(10) Pub. No.: US 2007/0236556 A1
(43) Pub. Date: Oct. 11, 2007

(54) Impinging optical beam on regions of label surface at different power levels

(76) Inventors: Kuohua Wu, Corvallis, OR (US); Andrew L. Van Brocklin, Corvallis, OR (US); Makarand P. Gore, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/400,667

(22) Filed: Apr. 8, 2006

(51) Int. Cl. B41J 2/47

(52) U.S. Cl. 347/253

(57) ABSTRACT

For each of a number of regions of a label surface of a substrate that are to be optically written to form a human-readable image, a corresponding power level at which an optical beam is to impinge the region to optically write a desired mark to the region as part of the image is determined. The optical beam impinges the region by being switched on and off from a higher power level to a lower power level to achieve the corresponding power level on average. At least one of the following are adjusted: a number of times the optical beam is switched on and off, a length of time the optical beam remains on each time it is switched on, and a duty cycle of the optical beam while the optical beam is positioned over the region.

### BACKGROUND

Optical disc drives have historically been used to optically read data from and optically write data to data regions of optical discs. More recently, optical disc drives have been used to optically write images to label regions of optical discs. For example, in the patent application entitled “Integrated CD/DVD Recording and Label” [attorney docket 10011728-1], filed on Oct. 11, 2001, and assigned Ser. No. 09/976,877, a type of optical disc is disclosed in which a laser or other optical beam can be used to write to the label surface of an optical disc. However, the approach provided in this patent application does not necessarily lend itself to full color and/or grayscale labeling of an optical disc.

By comparison, the co-filed patent application entitled “Optical Disc Having Dye Layers That Locationally Change in Color Upon Exposure to an Optical Beam” [attorney docket no. 200503812-1], describes an approach for multiple-color optical disc labeling. The approach in this patent application utilizes an optical beam that impinges a region of the label surface of an optical disc at a power level corresponding to the color to which the region is to be changed. However, within the prior art, impinging an optical beam at different power levels is generally slow, which slows the optical disc labeling process.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated.

FIGS. 1A, 1B, and 1C are diagrams of an optical disc, according to varying embodiments of the invention.

FIG. 2 is a diagram depicting how regions of the label surface of an optical disc can be selectively changed to one of three colors, based on the power level of an optical beam to which the regions are exposed, according to an embodiment of the invention.

FIG. 3 is a diagram depicting how regions of the label surface of an optical disc can be selectively changed to a color within a range of colors, based on the power level of an optical beam to which the regions are exposed, according to an embodiment of the invention.

FIG. 4 is a diagram depicting how a region can be exposed to a desired power level of an optical beam in accordance with the prior art.

FIGS. 5, 6, 7, 8, and 9 are diagrams depicting how a region can be exposed to a desired power level, according to varying embodiments of the invention.

FIG. 10 is a flowchart of a method for optically writing a multiple-color image to the label surface of an optical disc, according to an embodiment of the invention.

FIG. 11 is a diagram of an optical disc drive, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

It is noted that embodiments of the invention are substantially described in relation to an optical disc. However, other embodiments of the invention are applicable to other types of substrates. That is, a substrate may be or may be part of an optical disc, or may be part of another type of material that may or may not be rotated upon insertion in a storage device like an optical disc drive. Thus, whereas the following description is directed towards an optical disc, other embodiments of the invention are applicable to substrates other than an optical disc.

Optical Disc Marking

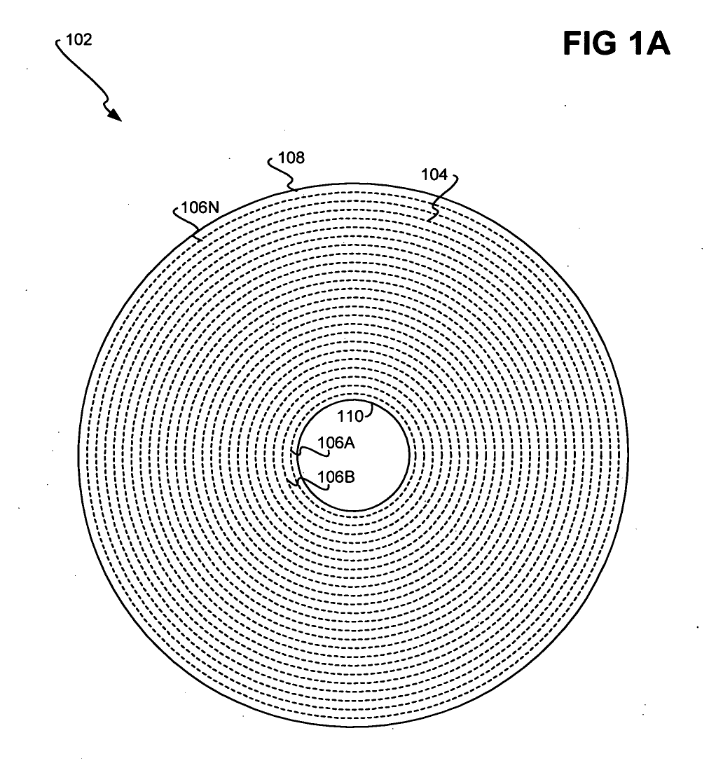

FIG. 1A shows the label surface 104 of an optical disc 102, according to an embodiment of the invention. The label surface 104 can be considered as having a number of logical tracks 106A, 106B, . . . , 106N, collectively referred to as the tracks 106, extending from an inner circumference 110 to an outside circumference 108 of the optical disc 102. The tracks 106 are depicted in FIG. 1 as being concentric circular tracks. However, in another embodiment, the tracks 106 may be different portions of a single spiral extending from the inner circumference 110 to the outside circumference 108 of the optical disc 102.

The tracks 106 are logical in the sense that, at least in some embodiments of the invention, they are not physically preformed or otherwise formed on the label surface 104. Rather, the tracks 106 denote and correspond to the paths over which an optical beam travels to selectively write to the label surface 104 to form a desired image on the label surface 104, as is described in more detail later in the detailed description. Thus, as the optical disc 102 rotates, an optical beam, such as a laser, is moved to the different tracks 106 and selectively impinges the label surface 104 on different positions or regions of the tracks 106 to write a desired image on the label surface 104.

FIG. 1B shows a portion of the label surface 104 of the optical disc 102 in more detail, according to an embodiment of the invention. Specifically, a portion of the track 106B is depicted in FIG. 1B as representative of all the tracks 106 of the label surface 104. The track 106B includes logical regions 112A, 112B, . . . , 112N, collectively referred to as the logical regions 112.

The regions 112 are logical in the sense that, in at least some embodiments of the invention, they are not physically preformed or otherwise formed on the label surface 104. Rather, the regions 112 denote and correspond to the different positions to which an optical beam may selectively write to the label surface 104A to form a desired image on the label surface 104, as is described in more detail later in the detailed description. Thus, as the optical disc 102 rotates, and when an optical beam is positioned over the track 106B, the optical beam selectively impinges the regions 112 to write a desired image on the label surface 104.

FIG. 1C shows a cross section of the optical disc 102, according to an embodiment of the invention. The optical disc 102 includes a substrate 114, on which the label surface 104 is disposed to one side of the substrate 114, and a data surface 116 is disposed on the other side of the substrate 114. While the label surface 104 is for optically writing a human-viewable image thereto, the data surface 116 is for optically writing data thereto. Thus, the optical disc 102 is a computer-readable medium, where a computing device may be able to write data to and/or read data from the data surface 116. By comparison, the primary purpose of the label surface 104 is for the formation of a human-viewable image thereon, which may, for instance, indicate what data has been stored on the data surface 116.

The terminology optically written is used in a broad sense herein. It can include opto-mechanical writing, as well as writing to a thermally sensitive surface. The optical part of this terminology can employ both visible light, as well as non-visible light, such as ultraviolet radiation, infrared radiation, and other types of electromagnetic radiation.

The data surface 116 of the optical disc 102 may be that of a compact disc (CD), a CD-readable (CD-R), which can be optically written to once, a CD-readable/writable (CD-RW), which can be optically written to multiple times, and so on. The data surface 116 may further be the data-recordable layer of a digital versatile disc (DVD), a DVD-readable (DVD-R), or a DVD that is readable and writable, such as a DVD-RW, a DVD-RAM, or a DVD+RW. The data surface 116 may also be the data-recordable layer of a high-capacity optical disc, such as a Blu-ray optical disc, and so on.

The label surface 104 may have one dye layer, or multiple dye layers. In general, the label surface 104 is able to locationally change in color upon exposure to an optical beam at a predetermined power level. “Locationally changing in color” means that the label surface 104 changes in color at the location where it is exposed to the optical beam. For example, each of the regions 112 of FIG. 1B can be selectively exposed to the optical beam, at different power levels, independent of the exposure of the optical beam to the other of the regions 112. In this way, different of the regions 112 can be changed to different colors or different grayscale to form an image on the label surface 104 of the optical disc 102.

More generally, and stated another way, each of one or more of the regions 112 of FIG. 1B can be exposed to a given power level of an optical beam to optically write a desired mark to the region as part of an image to be formed on the label surface 104 of the optical disc 102. In one embodiment, the colors of the marks written to one or more of the regions 112 vary depending on the power level of the optical beam when the optical beam impinges these regions. Thus, a desired mark optically written to a region may be a mark having a desired color or grayscale. In another embodiment, the size, shape, or other characteristics of the marks written to the regions 112 vary depending on the power level of the optical beam when the optical beam impinges these regions. Thus, a desired mark optically written to a region may be a mark having a desired size, shape, and/or another characteristic.

In one embodiment, there may particularly be two or more dye layers within the label surface 104, to provide for multiple-color labeling of the label surface 104 of the optical disc 102. Such dye layers are particularly described in the co-filed patent application entitled “Optical Disc Having Dye Layers That Locationally Change in Color Upon Exposure to an Optical Beam” [attorney docket no. 200503812-1], which is hereby incorporated by reference. In other embodiments, however, different types of label surfaces, besides that described in the referenced patent application, may be employed. In general, an image is formed on the label surface 104 of the optical disc 102 by locationally changing the color of the regions 112 of the label surface 104.

The image that is formed on the label surface 104 of the optical disc 102 is human-readable. That is, the image can be viewed and discerned by the human eye, and thus understood by a human, without the aid of a machine like an optical disc drive and/or a computing device. By comparison, the data stored on the data surface 116 is not viewable and discernable by the human eye without the aid of a machine like an optical disc drive and/or a computing device. That is, a human cannot view and discern the data stored on the data surface 116 without placing the optical disc 102 in an optical disc drive, which then reads the data and typically conveys the data to a computing device, which can then present the data to a human.

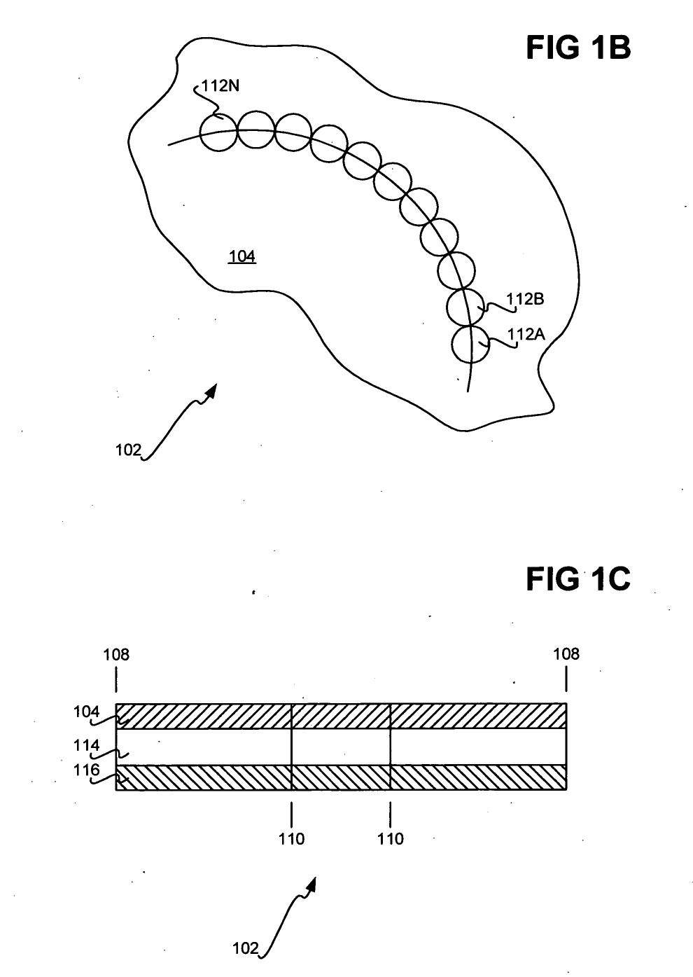

Two examples of how differing power levels at which an optical beam impinges a region of the label surface 104 of the optical disc 102 results in the region changing to different colors are now described. First, FIG. 2 shows how each region can be changed to one of a number of different discrete colors based on the power level at which the optical beam impinges the region in question, according to an embodiment of the invention. In particular, three different examples, denoted by the columns 202A, 202B, and 202C, show how different colors can be achieved for a given representative region 112B on the label surface of an optical disc. For each of these three examples, the row 204A shows the region 112B itself, and the row 204B depicts the power level of an optical beam that impinges the region 112B.

With respect to the row 204B, three power levels 205, 206, and 208 are particularly depicted. The power level 205 corresponds to a zero power level of the optical beam impinging the region 112B, such that the optical beam can be considered as not being turned on at all when passing over the region 112B. The power level 206 corresponds to a power level of the optical beam impinging the region 112B at which the dye layer 118 changes in color or grayscale. The power level 208 corresponds to a power level of the optical beam impinging the region 112B at which the dye layer 120 also changes in color, and is greater than the power level 206.

In the example of the column 202A, in the row 204B, the optical beam does not impinge the region 112B, as indicated by the arrow 210A, or stated another way, impinges the region 112B with a zero power level. As a result, the region 112B does not change color in the row 204A. In the example of the column 202B, in the row 204B, the optical beam impinges the region 112B at the first power level 206, as indicated by the arrow 210B. As a result, the region 112B in the row 204A is changed to a first color. Finally, in the example of the column 202C, in the row 204B, the optical beam impinges the region 112B at the second power level 208, as indicated by the arrow 210C, which is greater than the first power level 206. As a result, the region 112B in the row 204A is changed to a second color.

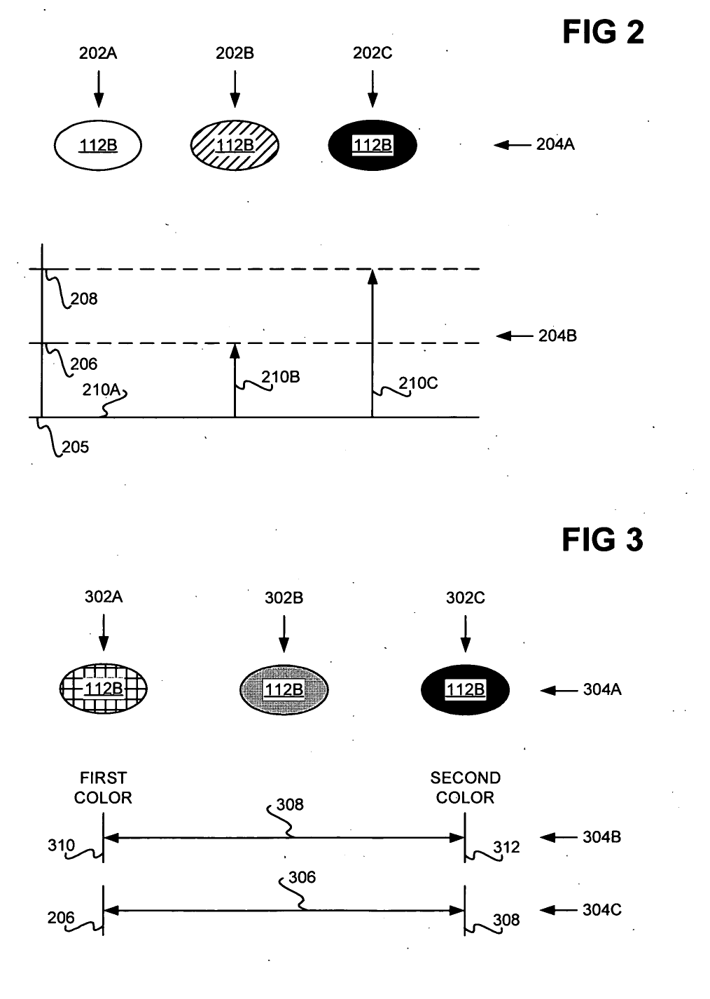

Second, FIG. 3 shows how each region of the label surface 104 of the optical disc 102 can be changed to one of a substantially continuous range of colors based on the power level at which the optical beam impinges the region in question, according to an embodiment of the invention. In particular, three different examples, denoted by the columns 302A, 302B, and 302C, show how different colors can be achieved for a given representative region 112B on the label surface of an optical disc. For each of these three examples, the row 304A shows the region 112B itself, the row 304B depicts the variation in color of the region 112B along a range of colors, and the row 304C depicts the power level of an optical beam that impinges the region 112B.

With respect to the row 304C, the two power levels 206 and 208 are particularly depicted. The power level 206 corresponds to a first power level of the optical beam impinging the region 112B. The power level 208 corresponds to a second power level of the optical beam impinging the region 112B that is greater than the power level 206.

In the example of the first column 302A, in the row 304C, the optical beam impinges the region 112B at the first power level 206. As a result, within the range of colors of the row 304B, as indicated by the line 308, the color of the region 112B in the row 304A changes to the first color indicated by the line 310. In the example of the last column 302C, in the row 304C, the optical beam impinges the region 112B at the second power level 208. As a result, within the range of colors of the row 304B, as indicated by the line 308, the color of the region 112B in the row 304A changes to the second color indicated by the line 312.

In the example of the middle column 302B, in the row 302C, the optical beam impinges the region 112B at a power level halfway between the first power level 206 and the second power level 208, along the at least substantially continuous range of power levels indicated by the line 306. As a result, within the at least substantially continuous range of colors of the row 304B, as indicated by the line 308, the color of the region 112B in the row 304A changes to a color half-way between the first color and the second color, presuming that the color changes linearly with the power level at which the optical beam impinges the region 112B. It is noted that the color may also change non-linearly with the power level in another embodiment of the invention.

Impinging Region of Label Surface of Optical Disc at Varying Power Levels

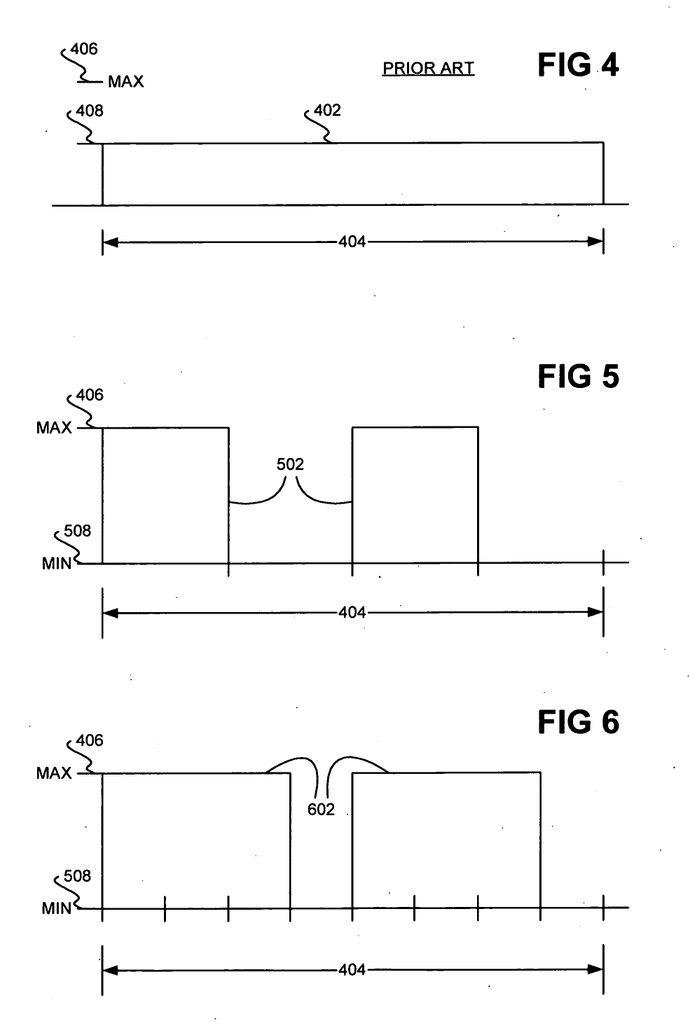

FIG. 4 shows how one of the regions 112 of the label surface 104 of the optical disc 102 is impinged by an optical beam at a desired power level in accordance with the prior art. The optical beam is positioned over the region in question for a length of time 404. During the entire length of time 404 that the optical beam is positioned over this region, it is turned on, as indicated by the pulse 402, at the desired power level 408. For instance, in FIG. 4, the desired power level 408 is half of the maximum (or higher) power level 406 at which the optical beam can impinge the region.

Thus, within the prior art, if an optical beam is to impinge a region of the label surface 104 of the optical disc 102 at a given power level, it is turned on for the entire time it is positioned over the region at that power level. While this approach works, existing optical disc drives can have difficulty switching the optical beam to a desired power level quickly. Furthermore, this prior art approach adds additional cost to the power control circuit, since most power control circuits can only switch at frequencies measured in kilohertz, whereas embodiments of the invention can switch at frequencies measured in megahertz. Therefore, the optical disc 102 has to be rotated more slowly within the prior art, to accommodate the relatively slow power level switching speed of the optical beam. As a result, optically writing a human-readable image to the label surface 104 of the optical disc 102 can be undesirably slow.

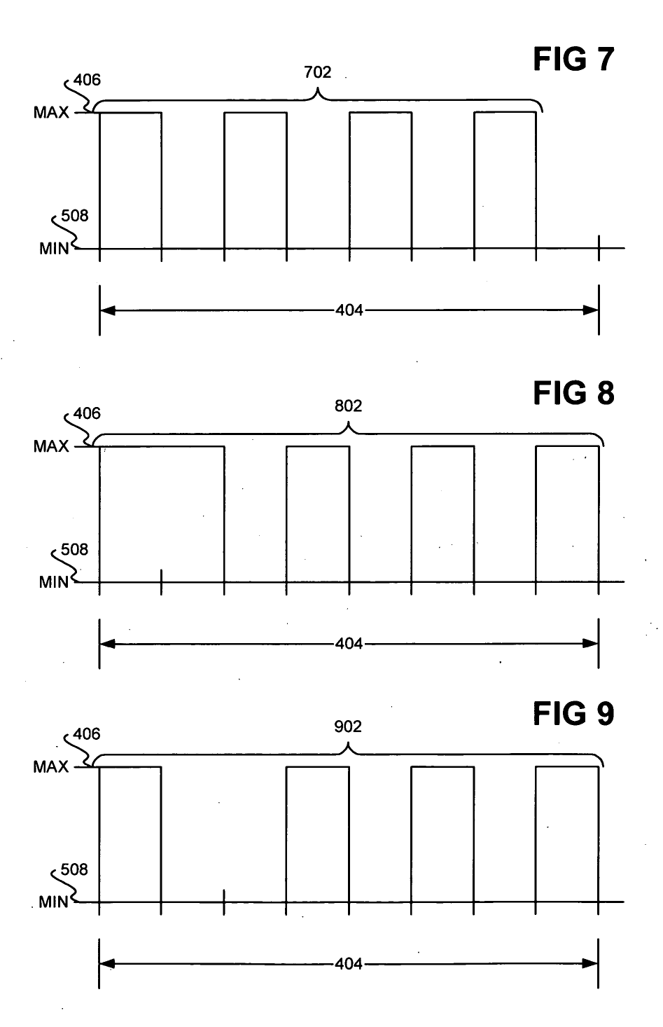

By comparison, FIG. 5 shows how one of the regions 112 of the label surface 104 of the optical disc 102 is generally impinged by an optical beam at a desired power level, according to an embodiment of the invention. As before, the optical beam is positioned over the region in question for the length of time 404. During the length of time 404 that the optical beam is positioned over this region, the optical beam is switched on and off from the maximum power level 406 to a minimum (or lower) power level 508, which may be zero, a number of times to achieve the corresponding desired power level on average, as indicated by the pulses 502.

For instance, in the example of FIG. 5, the optical beam is turned on for two pulses 502 at the maximum power level 406, which together represent half of the length of time 404 that the optical beam is positioned over the region in question. Therefore, on average, over the entire length of time 404, the optical beam is effectively at the desired power level of half the maximum power level 406. In the example of FIG. 5, further, two pulses are employed, whereas in actuality a larger number of shorter pulses may be used. The net effect in FIG. 5 is at least substantially that the region in question changes in color no different than if the optical beam had been turned on for the entire length of time 404 at half of the maximum power level 406, as in FIG. 4.

Embodiments of the invention provide for advantages over the prior art. Existing optical disc drives can quickly switch the optical beam to the maximum power level and to the minimum power level, typically zero. Therefore, the optical disc 102 can be rotated more quickly than in the prior art, while still providing for different regions 112 of the label surface 104 of the optical disc 102 being optically written on average at different power levels. As a result, optically writing a human-readable image to the label surface 104 of the optical disc 102 can be achieved more quickly than in the prior art.

In other words, with at least some types of compositions or formulations of the label surface 104 of the optical disc 102, a region on the label surface 104 is marked as desired based on the total amount of power of the optical beam to which the region is to be exposed during the length of time 404 at which the optical beam is positioned relative to the region. Therefore, what is important in such embodiments of the invention is not the instant power level of the optical beam at any given time during the length of time 404 at which the optical beam is positioned over the region. Rather, what is important is the average power level of the optical beam over the entire length of time 404 at which the optical beam is positioned over the region or surrounding region. Thus, the optical beam switching strategy of the embodiment of FIG. 5 results in at least substantially the same marking as the prior art of FIG. 4 does, but in a more efficient manner.

Different strategies can be employed within the general precept of switching the optical beam on and off from the maximum power level to the minimum power level to achieve a desired power level on average over the length of time at which the optical beam is positioned over a region of the label surface 104 of the optical disc 102 to write a desired mark to this region. For example, FIG. 6 shows how the length of time the optical beam remains on each time it is switched on can be adjusted to vary the corresponding power level of the optical beam to which a region is exposed on average, according to an embodiment of the invention.

As in FIG. 5, in FIG. 6 the optical beam is switched on and off from the maximum power level 406 to the minimum power level 508 twice, as indicated by the pulses 602, during the length of time 404 that the optical beam is positioned over the region in question. However, in FIG. 6, each time the optical beam is switched on to the maximum power level 406, the length of time the optical beam remains at the maximum power level 406 each time it is switched on is fifty percent greater than in FIG. 5. Therefore, whereas in FIG. 5 the average power level of the optical beam to which the region is exposed over the entire length of time 404 is half of the maximum power level 406, in FIG. 6 the average power level of the optical beam to which the region is exposed over the entire length of time 404 is 75% of the maximum power level 406.

FIG. 6 thus shows how the duty cycle of the optical beam can be varied in one embodiment to achieve the exposure of a region of the label surface 104 of the optical disc 102 to a desired power level of the optical beam on average. The duty cycle of the optical beam in this respect means the length of time the optical beam is turned on to the maximum power level 406 during the entire length of time 404 at which the optical beam is positioned over (or under) the region in question. Whereas the duty cycle of the optical beam in FIG. 5 is 50%, in FIG. 6 it is 75%, by adjusting the time the optical beam stays on at the maximum power level 406 each time the optical beam is switched on. Thus, any desired power level in any size of region can be achieved by changing the number of pulses of the optical beam impinging the region, or the duty cycle of these pulses.

The duty cycle of the optical beam can also be equivalently said to be varied by adjusting the length of time the optical beam stays off at the minimum power level 508 each time the optical beam is switched off during the entire length of time 404 at which the optical beam is positioned relative to the region in question. For example, as opposed to as in FIG. 5, in which the duty cycle of the optical beam in FIG. 5 is 50%, in FIG. 6 it is 75%, by adjusting the time the optical beam stays off at the minimum power level 508 each time the optical beam is switched off.

Furthermore, FIG. 7 shows how the number of times the optical beam is switched on can be adjusted to vary the corresponding power level of the optical beam to which a region is exposed on average, according to an embodiment of the invention. Whereas in FIGS. 5 and 6 the optical beam is switched on and off from the maximum power level 406 to the minimum power level 508 twice, in FIG. 7 the optical beam is switched on and off from the level 406 to the level 508 four times, as indicated by the pulses 702, during the length of time 404 that the optical beam is positioned over the region in question. The average power level of the optical beam to which the region is exposed over the entire length of time 404 is in FIG. 7 half of the maximum power level 406, similar to as in FIG. 5.

That is, in FIG. 5, the optical beam is switched on twice, each time for a length of time equal to one-quarter of the entire length of time 404. By comparison, in FIG. 7, the optical beam is switched on four times, each time for a length of time equal to one-eighth of the entire length of time 404. The net effect of the switching strategy of FIG. 7 is thus the same as that of FIG. 5, in that the region is exposed to an average power level of the optical beam equal to half of the maximum power level 406. Thus, a similar type of mark may be written to the label surface 104 of the, optical disc 102, regardless of whether the example of FIG. 5 is followed or the example of FIG. 7 is followed.

In the examples of FIGS. 5, 6, and 7, the pulses 502, 602, and 702, respectively, have been depicted as being regular. That is, all of the pulses 502 of FIG. 5 have the same length, all of the pulses 602 of FIG. 6 have the same length, and all of the pulses 702 have the same length. Thus, each time the optical beam is turned on at the maximum power level 408, it is turned on for the same length of time as compared to the other times the optical beam is turned on in any one example.

Likewise, adjacent of the pulses 502 of FIG. 5 are separated by the same length, adjacent of the pulses 602 of FIG. 6 are separated by the same length, and adjacent of the pulses 702 of FIG. 7 are separated by the same length. Thus, each time the optical beam is turned off to the minimum power level 508, it is turned off for the same length of time as compared to the other times the optical beam is turned off in any one example. As such, regular pulses are those that occur at a constant frequency, and which have a constant period.

However, in other embodiments, the pulses may be irregular, such that they do not occur at constant frequency, and/or do not have a constant period. For example, FIG. 8 shows how the optical beam can be turned on for different periods, according to an embodiment of the invention. As before, the optical beam is positioned over one of the regions 112 of the label surface 104 of the optical disc 102 for the length of time 404. During the length of time 404 that the optical beam is positioned over this region, it is switched on and off from the maximum power level 406 to the minimum power level 508, a number of times to achieve a corresponding desired power level on average, as indicated by the pulses 802.

However, the first time the optical beam is turned on in the example of FIG. 8, it is turned on for a length of time equal to one-fourth of the length of time 404. By comparison, the second through fourth times the optical beam is turned on, it is turned on for a length of time equal to one-eighth of the length of time 404. Thus, the length of time that the optical beam remains on during the first of the pulses 802 is different than the lengths of time the optical beam remains on during the second, third, and fourth of the pulses 802. As such, the pulses 802 are irregular, in that they have different periods. In FIG. 8, the optical beam is at the maximum power level 406 five-eighths of the entire length of time 404, resulting in an effective power level on average of 62.5% of the maximum power level 406 over the entire length of time 404.

As another example, FIG. 9 shows how the optical beam can be turned on at different frequencies, according to an embodiment of the invention. The optical beam is again positioned over one of the regions 112 of the label surface 104 of the optical disc 102 for the length of time 404. During the length of time 404 that the optical beam is positioned over this region, it is switched on and off from the maximum power level 406 to the minimum power level 508, a number of times to achieve a corresponding desired power level on average, as indicated by the pulses 902.

However, after the first time the optical beam is turned on in the example of FIG. 9, it is turned off for a length of time equal to one-fourth of the length of time 404. By comparison, the second through fourth times the optical beam is turned on are separated by lengths of time in which the optical beam is turned off each equal to one-eighth of the length of time 404. Thus, the length of time that the optical beam remains off after the first of the pulses 804 is different than the lengths of time the optical beam remains off between successive of the second, third, and fourth of the pulses 804. As such, the pulses 802 are irregular. Although the pulses 802 each have the same period, the first pulse occurs at a different frequency as compared to the other pulses. In FIG. 9, the optical beam is at the maximum power level 406 one-half of the entire length of time 404, resulting in an effective power level on average of 50% of the maximum power level 406 over the entire length of time 404.

Method and Optical Drive

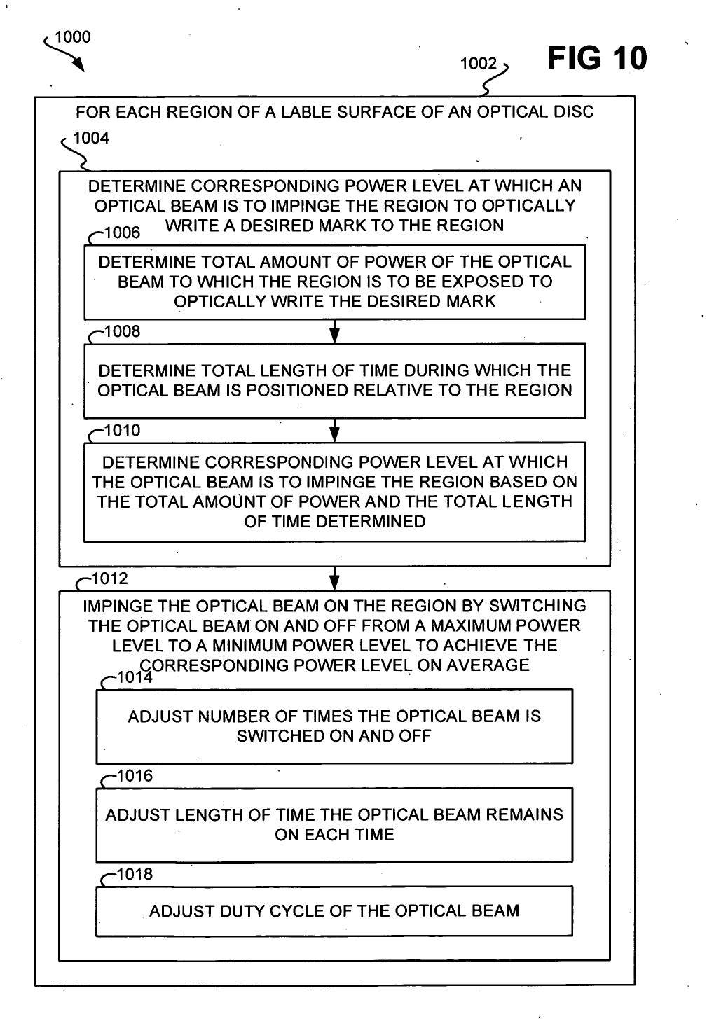

FIG. 10 shows a method 1000 for forming a human-readable image on the label surface of an optical disc, according to an embodiment of the invention. As indicated by reference number 1002, parts 1004 and 1012 are performed for each region of the label surface of an optical disc that is to have a marking written thereto. First, the corresponding power level at which an optical beam is to impinge the region in question to write a desired mark to the region is determined (1004). Part 1004 may be performed in one embodiment by performing parts 1006, 1008, and 1010.

Thus, the total amount of power of the optical beam to which the region is to be exposed to optically write the desired mark is determined (1006). The total length of time during which the optical beam is positioned relative to the region, such as over or under the region, is also determined (1008). For instance, the linear velocity at which the optical disc rotates while the optical beam is positioned relative to the region can be determined in order to determine the total length of time during which the optical beam is positioned relative to the region. Thereafter, the corresponding power level at which the optical beam is to impinge the region is determined based on the total amount of amount and the total length of time that have been determined (1010). For instance, the power level may be determined by dividing the total amount of power to which the region is to be exposed by the total length of time that the region is exposed to the optical beam.

Next, the optical beam is impinged on the region by switching the optical beam on and off, from a maximum power level to a minimum power level, such as zero, to achieve the corresponding power level on average (1012), as has been described. Part 1012 may be performed by performing parts 1014, 1016, and/or 1018. Thus, the number of times the optical beam is switched on and off may be adjusted (1014), as well as the length of time the optical beam remains on each time it is switched on (1016). Furthermore, the duty cycle of the optical beam can be adjusted (1018), as has been described. The pulses during which time the optical beam is turned on may be regular or irregular, as has also been described.

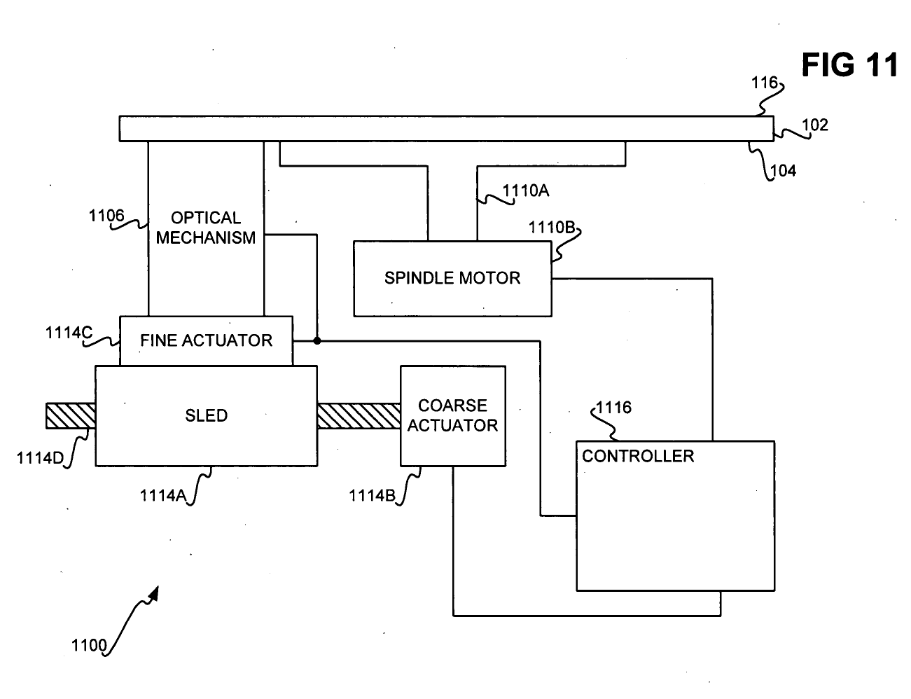

FIG. 11 shows an optical disc drive 1100, according to an embodiment of the invention. The optical drive 1100 is at least for optically writing a human-readable image to the label surface 104 of the optical disc 102. As can be appreciated by those of ordinary skill within the art, the components depicted in the optical drive 1100 are representative of one embodiment of the invention, and do not limit all embodiments of the invention.

The optical drive 1100 is depicted in FIG. 11 as including an optical mechanism 1106. The optical mechanism 1106 is capable of emitting optical beams of the same or different wavelengths at different power levels onto the optical disc 102 to cause the dye layers of the label surface 104 to write different markings as has been described. The optical mechanism 1106 may include a focusing mechanism, such as an objective lens.

The optical drive 1100 is also depicted in FIG. 11 as including a spindle 1110A and a spindle motor 1110B, which are collectively referred to as the first motor mechanism 1110. The spindle motor 1110B rotates the spindle 1110A, such that the optical disc 102 correspondingly rotates. The first motor mechanism 1110 may include other components besides those depicted in FIG. 11. For instance, the first motor mechanism 1110 may include a rotary encoder or another type of encoder to provide for control of the spindle motor 1110B and the spindle 1110A.

The optical drive 1100 is further depicted in FIG. 11 as including a sled 1114A, a coarse actuator 1114B, a fine actuator 1114C, and a rail 1114D, which are collectively referred to as the second motor mechanism 1114. The second motor mechanism 1114 moves the optical mechanism 1106 to radial locations relative to a surface of the optical disc 102. The coarse actuator 1114B is or includes a motor that causes the sled 1114A, and hence the fine actuator 1114C and the optical mechanism 1106 situated on the sled 1114A, to move radially relative to the optical disc 102 on the rail 1114D. The coarse actuator 1114B thus provides for coarse or large radial movements of the fine actuator 1114C and the optical mechanism 1106.

By comparison, the fine actuator 1114C also is or includes a motor, and causes the optical mechanism 1106 to move radially relative to the optical disc 102 on the sled 1114A. The fine actuator 1114C thus provides for fine or small movements of the optical mechanism 1106. The second motor mechanism 1114 may include other components besides those depicted in FIG. 11. For instance, the second motor mechanism 1114 may include a linear encoder or another type of encoder to provide for control of the coarse actuator 1114B and the sled 1114A. Furthermore, either or both of the motor mechanisms 1110 and 1114 may be considered as the movement mechanism of the optical drive 1100.

It is noted that the utilization of a fine actuator 1114C and a coarse actuator 1114B, as part of the second motor mechanism 1114, is representative of one, but not all, embodiments of the invention. That is, to radially move the optical mechanism 1106 in relation to the optical disc 102, the embodiment of FIG. 11 uses both a fine actuator 1114C and a coarse actuator 1114B. However, in other embodiments, other types of a second motor mechanism 1114 can be used to radially move the optical mechanism 1106 in relation to the optical disc 102, which do not require both a fine actuator 1114C and a coarse actuator 1114B. For instance, a single actuator or other type of motor may alternatively be used to radially move and position the optical mechanism 1106 in relation to the optical disc 102.

The optical drive 1100 is additionally depicted in FIG. 11 as including a controller 1116. The controller 1116 may be implemented in software, hardware, or a combination of software and hardware. The controller 1116 controls movement of the first motor mechanism 1110 and the second motor mechanism 1114 to move the optical mechanism 1106 in relation to the optical disc 102, and to rotate the optical disc 102. The controller 1116 is further to cause the optical mechanism 1106 to selectively emit optical beams at different power levels onto the regions of the label surface 104 of the optical disc 102 that are to have markings written to them, as has been described, to optically write a human-readable image on the label surface 104 of the optical disc 102.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of the disclosed embodiments of the present invention. Therefore, it is manifestly intended that this invention be limited only by the claims and equivalents thereof.

We claim:

1. A method comprising:
for each of a plurality of regions of a label surface of a substrate that are to be optically written to form a human-readable image,
determining a corresponding power level at which an optical beam is to impinge the region to optically write a desired mark to the region as part of the image; and,
impinging the optical beam on the region by switching the optical beam on and off from a higher power level to a lower power level to achieve the corresponding power level on average, by adjusting at least one of:
a number of times the optical beam is switched on and off, a length of time the optical beam remains on each time the optical beam is switched on, and a duty cycle of the optical beam while the optical beam is positioned over the region.

2. The method of claim 1, wherein impinging the optical beam on the region by switching the optical beam on and off from the higher power level to the lower power level to achieve the corresponding power level on average comprises adjusting the number of times the optical beam is switched on and off.

3. The method of claim 1, wherein impinging the optical beam on the region by switching the optical beam on and off from the higher power level to the lower power level to achieve the corresponding power level on average comprises adjusting the length of time the optical beam remains on each time the optical beam is switched on.

4. The method of claim 1, wherein impinging the optical beam oh the region by switching the optical beam on and off from the higher power level to the lower power level to achieve the corresponding power level on average comprises adjusting the duty cycle of the optical beam while the optical beam is positioned over the region.

5. The method of claim 1, wherein impinging the optical beam on the region by switching the optical beam on and off from the higher power level to the lower power level to achieve the corresponding power level on average comprises,
where the number of times the optical beam is switched on and off is greater than one,
adjusting the length of time the optical beam remains on each time the optical beam is switched on, such that at least one of the lengths of time the optical beam remains on is different than other of the lengths of time the optical beam remains on.

6. The method of claim 1, wherein impinging the optical beam on the region by switching the optical beam on and off from the higher power level to the lower power level to achieve the corresponding power level on average comprises,
where the number of times the optical beam is switched on and off is greater than one,
adjusting a length of time the optical beam remains off each time the optical beam is switched off after having been switched on, such that at least one of the lengths of times the optical beam remains off is different than other of the lengths of time the optical beam remains off.

7. The method of claim 1, wherein determining the corresponding power level at which the optical beam is to impinge the region to optically write the desired mark to the region comprises determining the corresponding power level at which the optical beam is to impinge the region to optically write the desired mark to the region, where the desired mark has a color based on the corresponding power level at which the optical beam is to impinge the region.

8. The method of claim 1, wherein determining the corresponding power level at which the optical beam is to impinge the region to optically write the desired mark to the region comprises determining the corresponding power level at which the optical beam is to impinge the region as one of a discrete number of different power levels.

9. The method of claim 1, wherein determining the corresponding power level at which the optical beam is to impinge the region to optically write the desired mark to the region comprises determining the corresponding power level at which the optical beam is to impinge the region as within a substantially continuous range of different power levels ranging from a first power level greater than zero to a second power level greater than the first power level.

10. The method of claim 1, wherein determining the corresponding power level at which the optical beam is to impinge the region to optically write the desired mark to the region comprises:
determining a total amount of power of the optical beam to which the region is to be exposed to optically write the desired mark to the region;
determining a total length of time during which the optical beam is positioned relative to the region; and,
determining the corresponding power level at which the optical beam is to impinge the region based on the total amount of power to which the region is to be exposed and the length of time during which the optical beam is positioned relative to the region.

11. The method of claim 10, wherein determining the total length of time during which the optical beam is positioned relative to the region comprises determining a velocity at which the substrate rotates while the optical beam is positioned relative to the region.

12. The method of claim 1, wherein the lower power level is zero.

13. An optical disc drive comprising:
an optical mechanism capable of emitting an optical beam at a minimum power level and at a maximum power level onto a label surface of an optical disc having a plurality of regions that are to be optically written to form a human-readable image; and,
a controller to cause the optical mechanism to emit the optical beam onto each region at a corresponding power level of a desired mark to be optically written to the region, by switching the optical beam on and off from the maximum power level to the minimum power level to achieve the corresponding power level of the desired mark,
wherein the controller is to switch the optical beam on and off to achieve the corresponding power level by adjusting at least one of: a number of times the optical beam is switched on and off, a length of time the optical beam remains on each time the optical beam is switched on, and a duty cycle of the optical beam while the optical beam is positioned over the region.

14. The optical disc drive of claim 13, wherein the controller is to adjust the number of times the optical beam is switched on and off while the optical beam is positioned over each region to achieve the corresponding power level of the desired mark to be optically written to the region.

15. The optical disc drive of claim 13, wherein the controller is to adjust the length of time the optical beam remains on each time the optical beam is switched on while the optical beam is positioned over each region to achieve the corresponding power level of the desired mark to be optically written to the region.

16. The optical disc drive of claim 15, wherein the number of times the optical beam is switched on and off is greater than one, and at least one of the lengths of time the optical beam remains on is different than other of the lengths of time the optical beam remains on.

17. The optical disc drive of claim 15, wherein the number of times the optical beam is switched on and off is greater than one, and at least one length of time the optical beam remains off is different than another length of time the optical beam remains off.

18. The optical disc drive of claim 13, wherein the controller is to adjust the duty cycle of the optical beam while the optical beam is positioned over each region to achieve the corresponding power level of the desired mark to be optically written to the region.

19. An optical disc drive comprising:
means for emitting an optical beam at a minimum power level and at a maximum power level onto a label surface of an optical disc having a plurality of regions that are to be optically written to form a human-readable image; and,
means for causing emission of the optical beam onto each region at a corresponding power level of a desired mark to be optically written to the region, by switching the optical beam on and off from the maximum power level to the minimum power level to achieve the corresponding power level of the desired mark.
